(19) United States
(12) Patent Application Publication
(10) Pub. No.: US 2010/0304767 A1
(43) Pub. Date: Dec. 2, 2010

(54) Wireless Communication System, Mobile Communication Apparatus, and Operating Method Thereof

(75) Inventor: Shih Hao Chen, Hsinchu Hsien (TW)

Correspondence Address: EDELL, SHAPIRO & FINNAN, LLC, 1901 RESEARCH BOULEVARD, SUITE 400, ROCKVILLE, MD, 20850, US

(73) Assignee: MStar Semiconductor, Inc., Hsinchu Hsien (TW)

(21) Appl. No.: 12/539,695

(22) Filed: Aug. 12, 2009

(30) Foreign Application Priority Data
May 27, 2009 (TW) 098117688

(51) Int. Cl. H04W 4/14

(52) U.S. Cl. 455/466

(57) ABSTRACT

A mobile communication apparatus includes a transmitting/receiving module, for receiving a setting short message comprising setting information; a setting module, coupled to the transmitting/receiving module, for receiving the setting information from the transmitting/receiving module, and setting an operation mode according to the setting information, wherein the operation mode comprises a condition and a predetermined action corresponding to the condition; a judgment module, coupled to the setting module, for monitoring an operation status and generating a judgment result when the operation status matches the condition; and a control module, coupled to the judgment module, for performing the predetermined action according to the judgment result.

### CROSS REFERENCE TO RELATED PATENT APPLICATION

This patent application is based on Taiwan, R.O.C. patent application No. 098117688 filed on May 27, 2009.

### FIELD OF THE INVENTION

The present invention is related to a short message transmission and processing, and is more particularly associated with a wireless communication system, a mobile communication apparatus and an operating method thereof. According to the content of the short message, a mobile communication apparatus is configured for forwarding a short message or reporting a current position for a purpose of saving short message transmitting costs or time.

### BACKGROUND OF THE INVENTION

As the improvement of wireless communication technology continues, a variety of communication apparatus with different functions, such as smart phone and PDA, have become indispensable communication tools in modern daily life. Besides the basic talking function, sending and receiving short message functions are most commonly used.

In general, nowadays the short message function is designed for transmitting text messages between users, and then the user reads the message by eyes. However, nowadays a mobile communication apparatus does not have reading and recognizing abilities on the content of short messages. Therefore, a mobile communication apparatus cannot reconfigure its settings according to a received short message, such as setting or adjusting power-on/off time, transferring calls and forwarding short messages. As a result, the user cannot remotely change the setting of a mobile apparatus through a short message. In addition, when short messages forwarding requirement arises, the messages received by a mobile phone can only be manually forwarded to another mobile phone. This above method is not only inconvenient but also time-consuming. For example, content of an urgent message can not immediately reach an intended recipient to notify the recipient. Further, since the charge for short message transmission within a same telecommunication services network is usually lower than that between different services networks, the costs shall be quite high when a large amount of short messages are transmitted between different services networks.

Therefore, the present invention provides a wireless communication system, mobile communication apparatus and the operating method thereof to solve the above problems.

### SUMMARY OF THE INVENTION

An embodiment of the present invention is a wireless communication system. In this embodiment, the wireless communication system comprises a mobile communication apparatus. The mobile communication apparatus sets an operation mode thereof according to setting information when receiving a setting short message comprising the setting information, wherein the operation mode comprises a condition and a predetermined action corresponding to the condition. The mobile communication apparatus shall perform the predetermined action when judging that the operating condition thereof matches the judgment condition.

Another embodiment of the present invention is a method for operating a mobile communication apparatus. In this embodiment, the method for operating a mobile communication apparatus, comprises steps of receiving a setting short message comprising setting information; setting an operation mode according to the setting information, wherein the operation mode comprises a condition and a predetermined action corresponding to the condition; monitoring an operation status and generating a judgment result when the operation status matches the condition; and performing the predetermined action according to the judgment result.

Another embodiment of the present invention is a mobile communication apparatus. In this embodiment, the mobile communication apparatus comprises a transmitting/receiving module, for receiving a setting short message comprising setting information; a setting module, coupled to the transmitting/receiving module, for receiving the setting information from the transmitting/receiving module, and setting an operation mode according to the setting information, wherein the operation mode comprises a condition and a predetermined action corresponding to the condition; a judgment module, coupled to the setting module, for monitoring an operation status and generating a judgment result when the operation status matches the condition; and a control module, coupled to the judgment module, for performing the predetermined action according to the judgment result.

Through the description of the above embodiments, according to the present invention, the mobile communication apparatus and the operating method thereof can set an operation mode of the mobile communication apparatus according to the setting short message. The mobile communication apparatus shall perform a predetermined action corresponding to the judgment condition when the operation condition thereof matches a judgment condition of the operation mode. In this way, the mobile communication apparatus and the operating method thereof according to the present invention can perform the functions of forwarding a short message or reporting a current position according to the short message. Therefore, costs and time for transmitting the short message can be saved according to user different requirements in practical applications.

### BRIEF DESCRIPTION OF THE DRAWINGS

The present invention will become more readily apparent to those ordinarily skilled in the art after reviewing the following detailed description and accompanying drawings, in which:

FIGS. 1A and 1D are schematic diagrams of a wireless communication system according to a first embodiment of the present invention; FIG 1B is an example of the setting information of a setting short message Mₛₑₜ; FIG. 1C is an example of a look-up table;

FIG. 2 is a functional block diagram of a mobile communication apparatus;

FIGS. 3A and 3B show an example of a wireless communication system operation;

FIGS. 4A to 4C show another example of a wireless communication system operation;

FIGS. 5A to 5C show schematic diagrams of forwarding short messages using a dual communication mode mobile communication apparatus for saving short message transmission costs;

FIG. 6A shows short message transmission costs between mobile communication apparatus A to D; FIG. 6B shows a schematic diagram of a short message forwarding path for saving the short message transmission costs; FIG. 6C shows a schematic diagram of a short message forwarding path for saving the short message transmission time;

FIG. 7 shows a flow chart of an operating method for the mobile communication apparatus according to a second embodiment of the present invention; and

FIGS. 8A and 8B show detailed flow charts of Step S12 and S14 in FIG. 7 respectively.

### DETAILED DESCRIPTION OF THE PREFERRED EMBODIMENT

It is an objective of the present invention to provide a wireless communication system, a mobile communication and an operating method thereof.

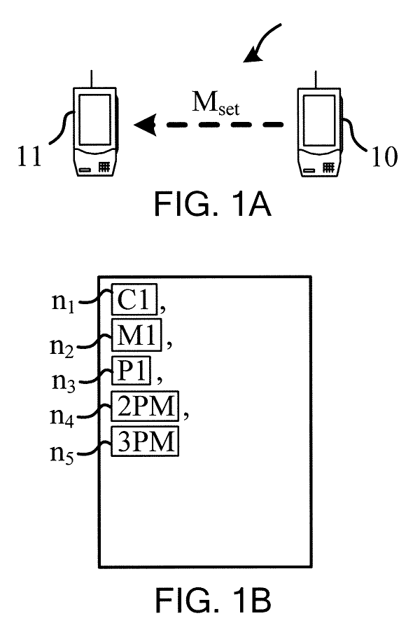

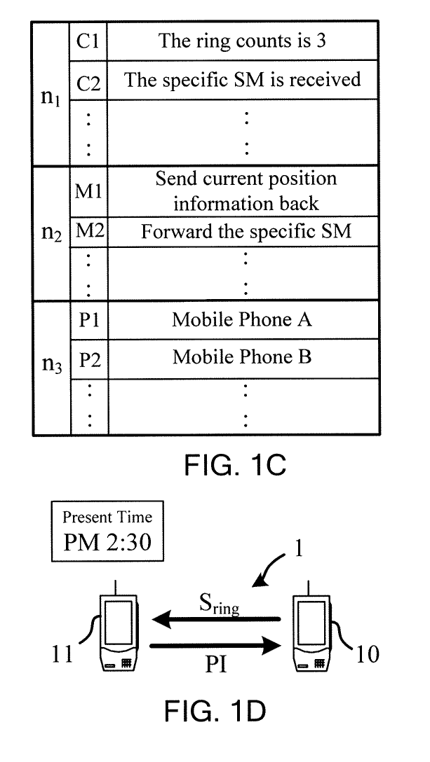

FIG. 1A shows a diagram of the wireless communication system according to an embodiment of the present invention. As shown in FIG. 1A, a wireless communication system 1 comprises a first mobile communication apparatus 10 and a second mobile communication apparatus 11. In this embodiment, the first mobile communication apparatus 10 transmits a setting short message Mₛₑₜ including setting information to the second mobile communication apparatus 11.

FIG. 1B shows an example of the setting information of the setting short message Mₛₑₜ. As shown in FIG. 1B, the setting information comprises five columns n₁ to n₅. In this embodiment, the column n₁ represents a condition, the column n₂ represents a predetermined action, the column n₃ represents a subject for performing the predetermined action, the column n₄ represents a start time, and a column n₅ represents an end time. In practice, the number of the columns, the type of the columns, and the meaning of each column in the setting information, being dependent on actual requirements and different mobile communication apparatuses, are not meant to be limitations of the present invention. Each column in the setting information of the setting short message Mₛₑₜ in FIG. 1B is represented by a code, therefore the second mobile communication apparatus 11 shall find the information corresponding to the code in each column from a look-up table when receiving the setting short message Mₛₑₜ.

FIG. 1C shows an example of the look-up table described above. The look-up table may be in other forms and is not limited to the one shown as an example. Regarding the column n₁ in the setting short message Mₛₑₜ shown in FIG. 1C, if the column n₁ is C1, the condition is “three ring counts”; if the column n₁ is C2, the condition is “the short message from the predetermined source”. Regarding the column n₂ in the setting short message Mₛₑₜ, if the column n₂ is M1, the predetermined action is “transmit current position information back”; if the column n₂ is M2, the predetermined action is “forward the short message to the predetermined mobile apparatus”. Regarding the column n₃ in the setting short message Mₛₑₜ, if the column n₃ is P1, the subject is “mobile phone A”; if the column n₃ is P2, the subject is “mobile phone B”.

In the embodiment, the first mobile communication apparatus 10 sends the setting short message Mₛₑₜ to the second mobile communication apparatus 11. Then, the second mobile communication apparatus 11 obtains the content by translating the setting short message Mₛₑₜ through the look-up table. For example, the content is “During 2:00 p.m. to 3:00 p.m., when the second mobile communication apparatus 11 matches “3 ring counts” condition, the second mobile communication apparatus 11 sends the current position information back to the first mobile communication apparatus 10”. As shown in FIG. 1D, supposing the time is 2:30 p.m., the second mobile communication apparatus 11 receives a call signal S_{ring} and detects the ring count. When the ring counts is 3, the second mobile communication apparatus 11 sends the current position P1 back to the first mobile communication apparatus 10.

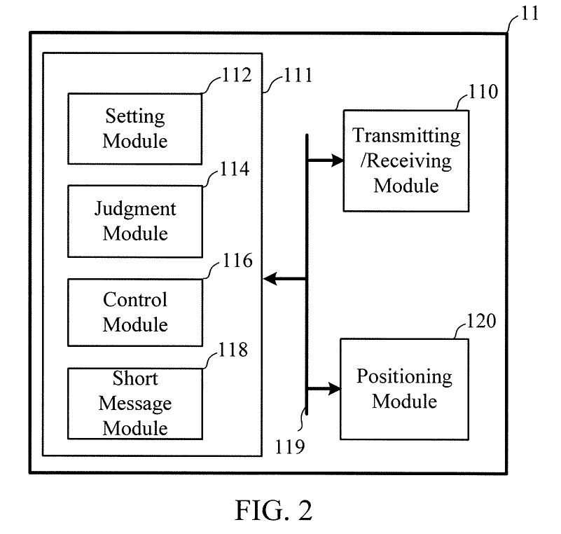

The structure of the second mobile communication apparatus 11 is described in detail below. FIG. 2 shows a functional block diagram of the second mobile communication apparatus 11. The second mobile communication apparatus 11 comprises a transmitting/receiving module 110, a processor 111, a data bus 119 and a positioning module 120. The processor 111 comprises, but not limited to, a setting module 112, a judgment module 114, a control module 116 and a short message module 118. The processor 111 is used for handling signal communication and data transmission between the transmitting/receiving module 110 and the positioning module 120 via the data bus 119.

In this embodiment, when the short message module 118 of the second mobile communication apparatus 11 receives the setting short message transmitted from the first mobile communication apparatus 10 through the transmitting/receiving module 110, the setting module 112 shall set the operation mode of the second mobile communication apparatus 11 according to the setting short message. For example, the operation mode may at least comprise a condition and a predetermined action corresponding to the condition.

When the setting module 112 completes setting the operation mode, the judgment module 114 continuously detects whether an operation situation of the second mobile communication apparatus 11 matches the condition. The control module 116 then performs the predetermined action when a judgment result from the judgment module 114 is affirmative.

As the example described above, the condition is “the second mobile communication apparatus 11 matches “3 ring counts” condition during 2:00 p.m. to 3:00 p.m.” and the predetermined action is “the second mobile communication apparatus 11 sends the current position information back to the first mobile communication apparatus 10”. Therefore, the judgment module 114 comprising a ringing detector detects whether the second mobile communication apparatus 11 receives a call signal and counts rings three times during 2:00 p.m. to 3:00 p.m. When the judgment result by the judgment module 114 is affirmative, it means the judgment module 114 detects that the second mobile communication apparatus 11 rings during 2:00 p.m. to 3:00 p.m. and the ring count is three. Then the control module 116 transmits the current position information back to the first mobile communication apparatus 10 through the transmitting/receiving module 110.

In this embodiment, the positioning module 120 of the second mobile communication apparatus 11 receives signals transmitted from a plurality of satellites of Global Positioning System (GPS) and accordingly calculates the current position information. The current position information comprises a current position coordinate of the second mobile communication apparatus 11. In general, besides GPS signals, the positioning module 120 can also receive signals transmitted from other positioning system, for example, satellites of Assisted Global Positioning System (AGPS), GLObal Navigation Satellite System (GLONASS), and Galileo navigation satellite system to accordingly calculate the current position information.

In practical applications, the present invention can be further applied to safety monitoring. For example, a mother carries the first mobile communication apparatus 10 and a child carries the second mobile communication apparatus 11. Through transmitting the setting short message Mₛₑₜ to the second mobile communication apparatus 11 from the first mobile communication apparatus 10, the mother can set the second mobile communication apparatus 11 carried by the child. When the second mobile communication apparatus 11 detects a call from the first mobile communication apparatus during the period of coming home from school, it reports the current position information back to the first mobile communication apparatus 10. Thus, through the present invention, the mother can obtain the child's position information in real time and save time and money of directly talking with the child by phone. In addition, the present invention can also be further applied to a truck tracking report system.

In practical applications, the second mobile communication apparatus 11 may verify the predetermined short message first. Only if the predetermined short message passes verification does the second mobile communication apparatus 11 forward the predetermined short message, thus reinforcing information security. The verifying method can be a verification code or others.

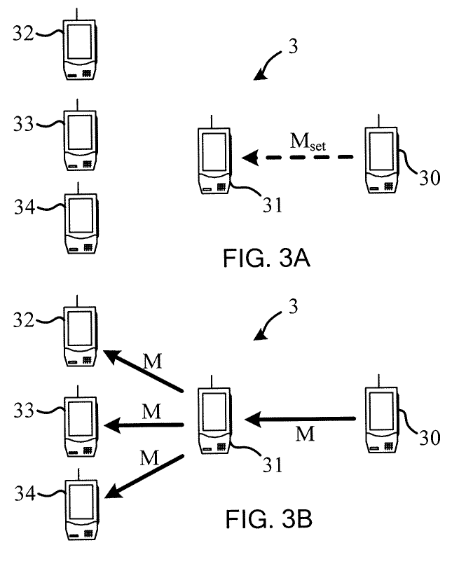

Another example is described for a practical operation condition of the wireless communication system in the present invention. As shown in FIG. 3A, the setting short message Mₛₑₜ transmitted from a first mobile communication apparatus 30 to a second mobile communication apparatus 31 is “when the second mobile communication apparatus 31 receiving predetermined short message M from first mobile communication apparatus 30, the second mobile communication apparatus 31 forwards the predetermined short message M to the third mobile communication apparatus 32, the fourth mobile communication apparatus 33 and the fifth mobile communication apparatus 34 respectively”. Therefore, when the transmitting/receiving module of the second mobile communication apparatus 31 receives the setting short message Mₛₑₜ transmitted from the first mobile communication apparatus 30, the setting module of the second mobile communication apparatus 31 shall set the operation mode of the second mobile communication apparatus 31 according to the setting information of the setting short message Mₛₑₜ.

As shown in FIG. 3B, the judgment module of the second mobile communication apparatus 31 judges whether the operation condition of the second mobile communication apparatus 31 matches the condition “receive the predetermined short message M from first mobile communication apparatus 30”. When the judgment result is affirmative, the control module of the second mobile communication apparatus 31 then forwards the predetermined short message M to the third mobile communication apparatus 32, the fourth mobile communication apparatus 33 and the fifth mobile communication apparatus 34, respectively.

It is noted that the mobile communication apparatus 32, the fourth mobile communication apparatus 33 and the fifth mobile communication apparatus 34 do not necessarily have the same structure as the second mobile communication apparatus 31—they are only capable of receiving a short message. The first mobile communication apparatus 30 is only capable of generating the setting short message Mₛₑₜ. The setting short message Mₛₑₜ may be one of predefined messages stored in the first mobile communication apparatus 30 or generated by a user through the input interface of the first mobile communication apparatus 30.

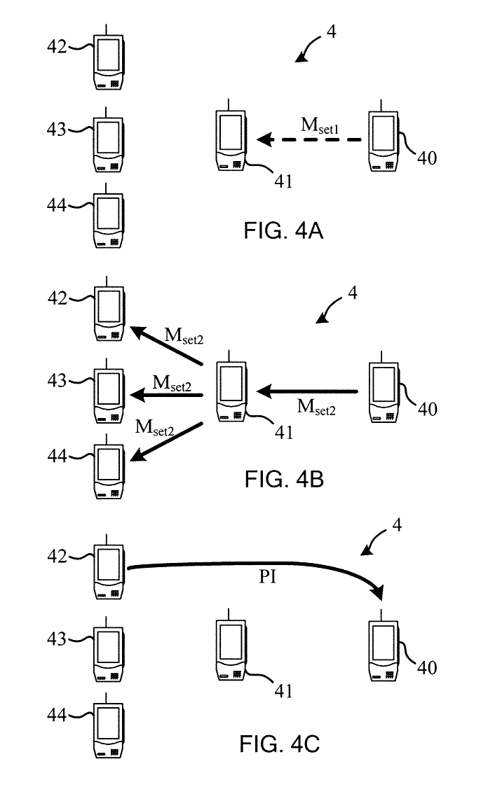

A schematic diagram of a mobile communication apparatus, which is used to receive the predetermined short message M from the second mobile apparatus, is described below. As shown in FIG. 4A, the first setting short message Mₛₑₜ₁, transmitted from the first mobile communication apparatus 40 to the second mobile communication apparatus 41, is “when the second mobile communication apparatus 41 receives the second setting short message Mₛₑₜ₂ from the first mobile communication apparatus 40, the second mobile communication apparatus 41 forwards the second setting short message Mₛₑₜ₂ to third mobile communication apparatus 42, fourth mobile communication apparatus 43 and fifth mobile communication apparatus 44 respectively”. Therefore, when the transmitting/receiving module of the second mobile communication apparatus 41 receives the first setting short message Mₛₑₜ₁, the setting module of the second mobile communication apparatus 41 sets the operation mode of the second mobile communication apparatus 41 according to the setting information of the first setting short message Mₛₑₜ₁.

As shown in FIG. 4B, the judgment module of the second mobile communication apparatus 41 judges whether the operation condition of the second mobile communication apparatus 41 matches the condition “the second mobile communication apparatus receives second setting short message Mₛₑₜ₂ from first mobile communication apparatus 40”. When the judgment result is affirmative, the control module of the second mobile communication apparatus 41 then forwards the second setting short message Mₛₑₜ₂ to the third mobile communication apparatus 42, the fourth mobile communication apparatus 43 and the fifth mobile communication apparatus 44, respectively.

It is noted that the third mobile communication apparatus 42, the fourth mobile communication apparatus 43 and the fifth mobile communication apparatus 44 all have similar operation conditions as the second mobile communication apparatus 41 because each of them has a same structure as the second mobile communication apparatus 41. Taking the third mobile communication apparatus 42 as an example, the second setting short message Mₛₑₜ₂ is “when receiving the second setting short message, transmit the current position information PI to the first mobile communication apparatus 40”. Therefore, as shown in FIG. 4C, the third mobile communication apparatus 42 shall transmit the current position to the first mobile communication apparatus 40 when receiving the second setting short message Mₛₑₜ₂.

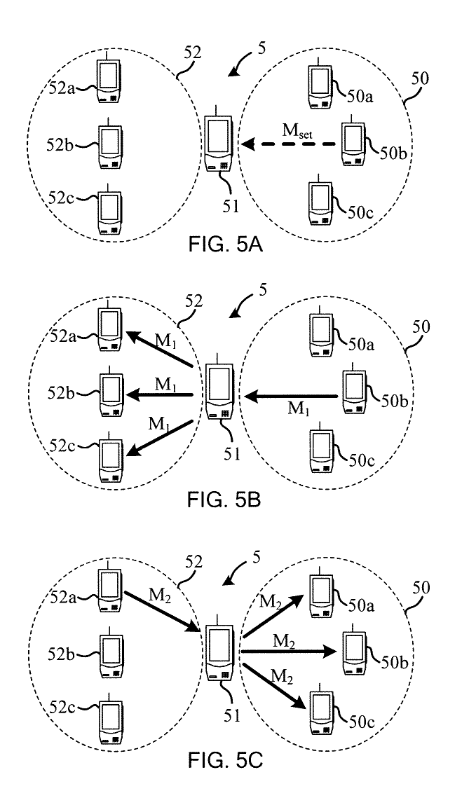

An example of how to save short message transmission costs through the present invention is described below. FIGS. 5A to 5C show schematic diagrams of forwarding short messages using a dual mode mobile communication apparatus for saving the short message transmission costs. As shown in FIG. 5A, in a wireless communication system 5, the first communication network 50 and the second communication 51 are operated by different frequency bands or different communication protocols. The first target mobile communication apparatus 50a to 50c and the second target mobile communication apparatus 52a to 52c can not communicate with each other. But those apparatus can communicated with the communication apparatus 51 directly.

In this embodiment, the setting short message Mₛₑₜ is “when the communication apparatus 51 receives the predetermined short message M₁/M₂ from the first target mobile communication apparatus 50a to 50c/the second target mobile communication apparatus 52a to 52c, the mobile communication apparatus 51 forwards the predetermined short message M₁/M₂ to the second target mobile communication apparatus 52a to 52c/the first target mobile communication apparatus 50a to 50c respectively”. Therefore, upon receiving the short message Mₛₑₜ, the mobile communication apparatus 51 sets the operation mode thereof according to the setting short message Mₛₑₜ.

As shown in FIG. 5B, the mobile communication apparatus 51 forwards the predetermined short message M₁ to the second target mobile communication apparatus 52a to 52c respectively through the second wireless communication network 52, when receiving the predetermined short message M₁ from the first target mobile communication apparatus 50b through the first wireless communication network 50. On the other hand, as shown in FIG. 5C, the mobile communication apparatus 51 forwards the predetermined short message M₂ to the first target mobile communication apparatus 50a to 50c respectively through the first wireless communication protocol, when receiving the predetermined short message M₂ from the second target mobile communication apparatus 52a through the second wireless communication protocol.

It is noted that the first and the second wireless communication network described above are not meant to be any limitations—they may be systems with a same communication technology of different service providers, or with different communication technologies. Common communication technologies comprise 2G (second-generation wireless mobile communication technology), 3G (third-generation wireless mobile communication technology), WLAN (wireless local access network ), WIMAX (Worldwide Interoperability for Microwave Access), 3.5G (3.5^{th}-generation wireless mobile communication technology, such as high speed downlink packet access (HSDPA) technology), 4G (fourth-generation wireless mobile communication technology, such as long term evolution (LTE)), or any other kind of wireless communication protocols.

In practical applications, the mobile communication apparatus 51 may be a dual-number cell phone with two numbers respectively provided by two different telecommunication service providers. Therefore, the mobile communication apparatus 51 communicates with the first target mobile communication apparatus 50a to 50c in the first wireless communication network 50 through the number belonged to the first telecommunication service provider; the mobile communication apparatus 51 communicates with the second target mobile communication apparatus 52a to 52c in the second wireless communication network 52 through the number of the second telecommunication service provider.

With the embodiments of the present invention, the short message transmission costs between mobile communication apparatus of different wireless communication networks can be lowered efficiently when short messages are forwarded by the mobile communication apparatus 51. The effect is more obvious especially when a large amount of short messages are transmitted.

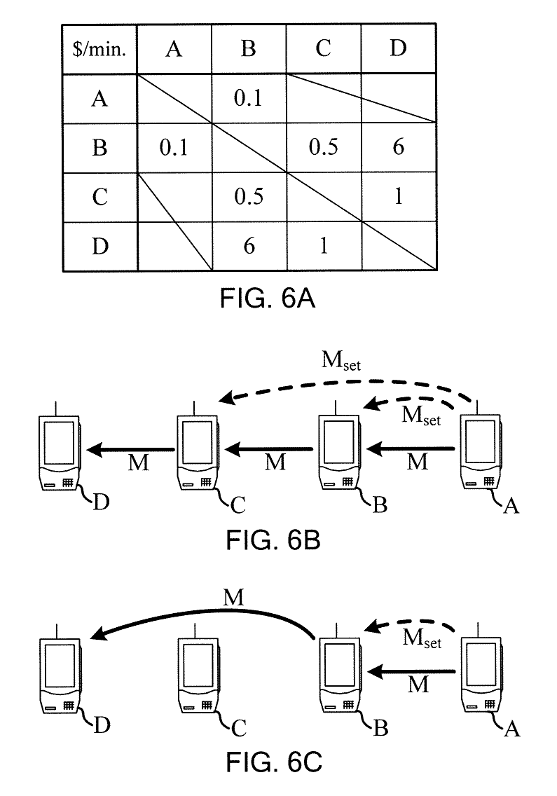

An example of how to save short message transmission costs and time through the present invention is described. FIG. 6A shows the short message transmission costs between mobile communication apparatus A to D. And the short message transmission time between any two apparatuses is fixed. When a user wishes to transmit a short message with a least cost from the mobile communication apparatus A to the mobile communication apparatus D, an optimum transmission path is A-B-C-D. The cost is 0.1 $/min+0.5 $/min+1 $/min=1.6 $/min. Therefore, as shown in FIG. 6B, to transmit the predetermined short message M on the optimum transmission path, the mobile communication apparatus A first transmits the setting short message Mₛₑₜ to the mobile communication apparatus B and C. Then the mobile communication apparatus B and C set the operation mode thereof according to the setting short message Mₛₑₜ. Next, the mobile communication apparatus B forwards the predetermined short message M to the mobile communication apparatus C when receiving the predetermined short message M from apparatus A; the mobile communication apparatus C similarly forwards the predetermined short message M to the mobile communication apparatus D when receiving the predetermined short message M from apparatus B.

When a user wishes to transmit within a shortest time a predetermined short message M from the mobile communication apparatus A to the mobile communication apparatus D, an optimum transmission path of the predetermined short message M is A, B, and D. The total transmission time, which comprises two periods of short message transmission time and one period of short message forwarding time, is the shortest; however, the total cost is 0.1 $/min+6 $/min=6.1 $/min. Therefore, as shown in FIG. 6C, to transmit the predetermined short message M on the optimum transmission path, the mobile communication apparatus A first transmits the setting short message Mₛₑₜ to the mobile communication apparatus B, which then sets the operation mode thereof according to the setting short message M_{set.} Next, the mobile communication apparatus B forwards the predetermined short message M to the mobile communication apparatus D when receiving the predetermined short message M. With the embodiments according to the present invention, a user is given an option of forwarding short messages using a time-saving approach or a money-saving approach through the mobile communication apparatus.

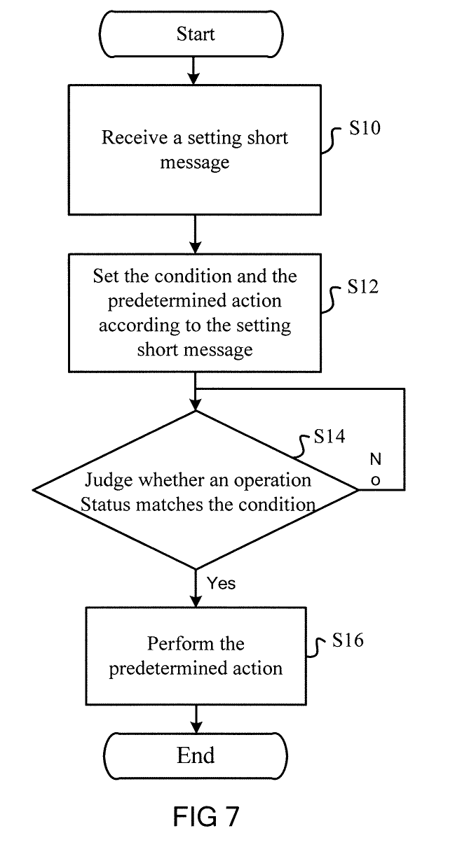

An operating method of a mobile communication apparatus is provided according to another embodiment of the present invention. FIG. 7 shows a flow chart of the operating method. As shown in FIG. 7, in Step S10, the mobile communication apparatus receives a setting short message. In Step S12, the mobile communication apparatus sets a condition of an operation mode thereof and a predetermined action corresponding to the condition according to the setting short message. Next, in Step S14, the mobile communication apparatus judges whether an operation condition thereof matches the condition. When a judgment result is affirmative, the mobile communication apparatus then performs the predetermined action in Step S16.

In practice, the condition may be associated with, for example, whether the ring counts of the mobile communication apparatus is equal to a predetermined value during a predetermined period, or whether the mobile communication apparatus receives a first predetermined short message during a predetermined period. The predetermined action may be, for example, transmitting a current position of the mobile communication apparatus, or forwarding the received predetermined short message.

In this embodiment, the mobile communication apparatus receives the first predetermined short message during the predetermined period. The mobile communication apparatus first determines the first mobile communication apparatus is the next apparatus according to a forwarding path, and then forwards the first predetermined short message to the first mobile communication apparatus. The forwarding path may be selected from a plurality of predetermined forwarding path according to a predetermined forwarding rule, which is associated with, for example, the transmission cost or time estimated by the forwarding path.

On the other hand, if the mobile communication apparatus receives a second predetermined short message from the first mobile communication apparatus during the predetermined period, the first mobile communication apparatus forwards the second predetermined short message to the second mobile communication apparatus according to the setting short message.

It is noted that the mobile communication apparatus communicates with the first mobile communication apparatus through the first wireless communication network, and communicates with the second mobile communication apparatus through a second wireless communication network. According to the above rule, the transmission cost of exchanging short messages between two groups of mobile communication apparatuses in different wireless networks can be lowered down.

Furthermore, in practical applications, for making sure the security, the mobile communication apparatus verifies the first predetermined short message/the second short predetermined message first. If the first predetermined short message/the second predetermined short message passes the verification, the mobile communication apparatus forwards the first predetermined short message/the second predetermined short message.

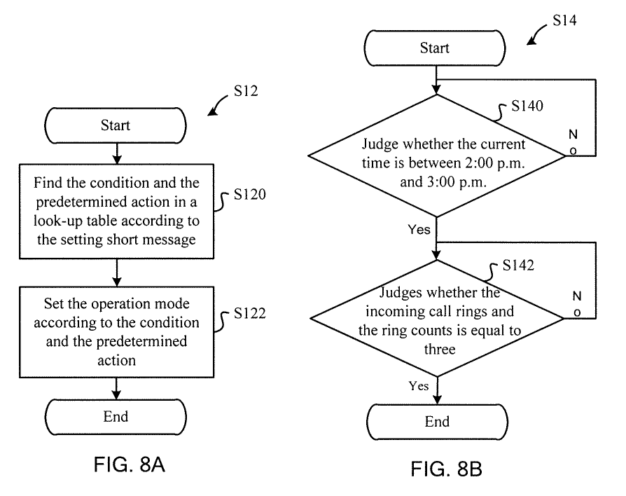

For example, the setting short message received by the mobile communication apparatus comprises five columns n₁ to n₅, as shown in FIG. 1B. Then the Step S12 described above can be divided into two sub-steps S120 and S122, as shown in FIG. 8A. In Step S120, the mobile communication apparatus shall find the condition and the predetermined action corresponding to the information in each column of the setting short message according to a look-up table. If the condition is “the mobile communication apparatus rings and the ring counts is equal to three during 2:00 p.m. to 3:00 p.m.”, and the predetermined action is “transmit the current position to the first target mobile communication apparatus”, the mobile communication apparatus then sets the operation mode according to the condition and the predetermined action in Step S122.

Step S14 can be divided into two sub-steps S140 and S142 as shown in FIG. 8B. In Step S140, the mobile communication apparatus judges whether the current time is between 2:00 p.m. and 3:00 p.m. by a timer. If the judgment result is affirmative, the mobile communication apparatus then judges whether the incoming call rings and the ring counts is equal to three in Step S142. If the judgment result of Step S142 is affirmative, Step S16 is then performed. It is noted that the sub-steps of Step S12 and S14 may be modified based on the practical applications, and are not limited to the examples described above.

A mobile communication apparatus is provided according to another embodiment of the present invention. In this embodiment, the mobile communication apparatus comprises a processor, a transmitting/receiving module, a data bus and a positioning module. The processor performs signal communication and data transmission between the transmitting/receiving module and the positioning module via the data bus. The processor comprises, but not limited to, a setting module, a judgment module, a control module and a short message module. A detailed function block diagram of the mobile communication apparatus is shown in FIG. 2. The functions and the operation conditions of the various modules comprised in the mobile communication apparatus are as described above, and shall not be again discussed.

Through the descriptions of the above embodiments, the mobile communication apparatus and the operating method thereof according to the present invention can set an operation mode of the mobile communication apparatus according to the setting short message. When the operation condition of the mobile communication apparatus corresponds to a judgment condition of the operation mode, the mobile communication apparatus performs the predetermined action corresponding to the condition. Therefore, the mobile communication apparatus and the operating method thereof according to the present invention can perform functions of forwarding a short message or reporting a current position according to the short message. Thus, costs and time for transmitting the short message can be saved according to different user requirements in practical applications.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A mobile communication apparatus, comprising:
a transceiver, for receiving a setting short message comprising setting information;
a setting module, coupled to the transceiver, for receiving the setting information from the transceiver, and setting an operation mode according to the setting information, wherein the operation mode comprises a condition and a predetermined action corresponding to the condition;
a judgment module, coupled to the setting module, for generating a judgment result by monitoring an operation status when the operation status matches the condition; and
a control module, coupled to the judgment module, for performing the predetermined action according to the judgment result.

2. The mobile communication apparatus as claimed in claim 1, wherein the setting module accesses the condition and the predetermined action from a look-up table according to the setting information.

3. The mobile communication apparatus as claimed in claim 1, wherein the condition is a ring count is equal to a predetermined value during a predetermined period.

4. The mobile communication apparatus as claimed in claim 1, wherein the condition is receiving a first predetermined short message during a predetermined period, and a predetermined action is the forwarding the first predetermined short message to another communication apparatus during the predetermined period.

5. The mobile communication apparatus as claimed in claim 4, wherein the control module determines another mobile communication apparatus to be a destination according to a forwarding path, and the forwarding path is determined according to predetermined forwarding rules.

6. The mobile communication apparatus as claimed in claim 5, wherein the predetermined forwarding rules correspond to transmission time and transmission cost.

7. The mobile communication apparatus as claimed in claim 6, wherein the mobile communication apparatus communicates with at the least one first mobile communication apparatus through a first wireless communication network, and communicates with at the least one second mobile communication apparatus through a second wireless communication network.

8. The mobile communication apparatus as claimed in claim 6, wherein the mobile communication apparatus verifies the predetermined short message and forwards the predetermined short message if the first predetermined short message passes the verification.

9. The mobile communication apparatus as claimed in claim 1, further comprising:
a positioning module, coupled to the control module, for receiving signals from a positioning system and calculating a current position information of the mobile communication apparatus;
wherein the predetermined action is transmitting the current position information and the control module transmits the current position information through the transmitting/receiving module according to the judgment result.

10. A method for operating a mobile communication apparatus, comprising steps of:
receiving a setting short message comprising setting information;
setting an operation mode according to the setting information, wherein the operation mode comprises a condition and a predetermined action corresponding to the condition;
generating a judgment result by monitoring an operation status when the operation status matches the condition; and
performing the predetermined action according to the judgment result.

11. The method as claimed in claim 10, wherein the condition is a ring count is equal to a predetermined value during a predetermined period.

12. The method as claimed in claim 10, wherein the condition is receiving a first predetermined short message during a predetermined period, and a predetermined action is the forwarding the first predetermined short message to another communication apparatus during the predetermined period.

13. The method as claimed in claim 12, the method further comprising a step of:
determining another mobile communication apparatus to be a destination according to a forwarding path, wherein the forwarding path is determined according to predetermined forwarding rules.

14. The method as claimed in claim 13, wherein the predetermined forwarding rules correspond to transmission time and transmission cost.

15. The method as claimed in claim 14, wherein the mobile communication apparatus communicates with at the least one first mobile communication apparatus through a first wireless communication network, and communicates with at the least one second mobile communication apparatus through a second wireless communication network.

16. The method as claimed in claim 15, the method further comprising a step of:
verifying the predetermined short message; and
forwarding the predetermined short message if the first predetermined short message passes the verification.

17. The method as claimed in claim 10, the method further comprising a step of:
receiving a signals from a positioning system and calculating a current position information of the mobile communication apparatus;
wherein the predetermined action is transmitting the current position information and the control module transmits the current position information through the transmitting/receiving module according to the judgment result.
